(19) United States
(12) Patent Application Publication
(10) Pub. No.: US 2013/0138662 A1
(43) Pub. Date: May 30, 2013

(54) Method for assigning user-centric ranks to database entries within the context of social networking

(71) Applicants: Zhijiang He, Sunnyvale, CA (US); Jiafang Xiao, (US)

(72) Inventors: Zhijiang He, Sunnyvale, CA (US); Jiafang Xiao, (US)

(73) Assignee: Dr. ZHIJIANG HE, SUNNYVALE, CA (US)

(21) Appl. No.: 13/373,778

(22) Filed: Nov. 29, 2011

(51) Int. Cl. G06F 17/30

(52) U.S. Cl. 707/748; 707/E17.014

(57) ABSTRACT

A method is provided for assigning user-centric importance ranks to database entries within the context of social networking. A database entry is assigned an importance rank with respect to a user based on the experiences of the user's social relations reachable in social graphs with the database entry or its related database entries. The assigned rank is dependent on the closeness of the user's social relations with the user and their authorities on the database entry. The closeness of relation between users is determined using information from social networking services. Importance ranks calculated from other methods may serve as initial estimates for the user-centric importance ranks. Moreover, a user may acquire more information about a database entry by either communicating with users having experiences with the entry or obtaining information from social networking services. The method improves search relevance and provides more personalized search results.

### CROSS-REFERENCE TO RELATED APPLICATIONS

Ser. No. 13/317,270, “A method for calculating distances between users in a social graph”, Oct. 13, 2011, pending, Zhijiang He

Ser. No. 13/317,794, “A method for calculating proximities between nodes in multiple social graphs”, October 28, pending, Zhijiang He

### FEDERALLY SPONSORED RESEARCH

Not Applicable

### SEQUENCE LISTING OR PROGRAM

Not Applicable

### US PATENT REFERENCES

U.S. Pat. No. 6,285,999, “Method for node ranking in a linked database”, filed on Jan. 9, 1998, issued on Sep. 4, 2001, Lawrence Page

### OTHER REFERENCES

“Six degrees of separation”, http://en.wikipedia.org/wiki/Six_degrees_of_separation

### FIELD OF THE INVENTION

The present invention relates generally to techniques for search in a database. More specifically, it relates to methods for assigning user-centric ranks to database entries within the context of social networking. The entries in a database may or may not have linking relation.

### BACKGROUND OF THE INVENTION

Relevance has been consistently challenging in search. Due to the imperfect representation of a user's search intention in terms of keywords, the matched entries' relevance to a user's search intention is hard to define. Various techniques have been applied to improving the relevance of search in a database. One of the most prominent is the PageRank algorithm used by Google, which remarkably ranks the nodes based on the relation between nodes in a linked database. The ranks of nodes are determined from the entries of the dominant eigenvector of a modified adjacency matrix representing the link structure of a linked database.

Fundamentally, ranks in the PageRank algorithm are determined by the dominant eigenvalue of a modified adjacency matrix. Compared to the remaining eigenvalues of a modified adjacency matrix, the dominant eigenvalue is a first order approximation to the characteristics of a modified adjacency matrix.

Moreover, regardless of individual users' search intentions, the original PageRank algorithm assigns same rank to a node in a linked database. In some sense, the rank of a node may be relevant to the dominant search intention among all possible search intentions.

Statistically, users' search intentions may be characterized as, a distribution of probability. The dominant search intention represented by user-independent ranks is equivalent to mean of the probability distribution. For personalized search, ranks of the nodes may be further tuned according to the search histories of a user and his/her friends. For example, machine learning techniques may be used to predict the search characteristics and preferences of a user.

However, the extent of search personalization based on a user's search history and his/her friends' histories is limited. For instance, if the matched database entries and their related database entries are new to a user and his/her friends, the search results may be most likely determined by user-independent ranks.

In recent years, social networking has become more and more popular. For instance, Facebook has more than half billion users. Large databases of social connections, i.e. social graphs, have been established. More importantly, according to the 6 degrees of separation, there may be on average 5 users between any two users of a popular social networking service. In other words, a user may easily connect to any other user on a popular social networking service.

In real life, a user may ask his/her friends for an answer to a specific question. His/her friends may ask their friends for an answer to the question. In this real life example, friendship may be used to find an answer to a question.

Similarly, social networking may bring new perspectives to personalized search in a database such as world wide web. Search in a database may be modeled as a process of knowledge propagation across relations in social graphs. It is assumed that some users may have already queried a database entry or its related database entries. It is further assumed that impact factors are defined to represent those users' experiences with the database entry or its related database entries. The importance rank of a database entry with respect to a user is determined from the impact factors associated with users who may connect to the user in social graphs.

A rank assigned to a database entry may represent a prediction of a user's level of interest, review, rating, opinion about the database entry. For instance, a user may query a database about dentists in a specific city. In this case, a rank assigned to a dentist entry with respect to a user may predict the user's level of interest, review, rating and opinion about the dentist. A larger rank assigned to a dentist may mean higher rating on the dentist. In other words, search relevance may include a user's possible level of interest, review, rating and opinion about a database entry. This may be an extended feature for search engines.

Accordingly, it is an object of this invention to provide a method for assigning user-centric ranks to database entries within the context of social networking.

### BRIEF SUMMARY OF THE INVENTION

The present invention provides a method for assigning user-centric ranks to database entries within the context of social networking. Information of profiles, relations, groups, messages, etc., is obtained from social networking services with users' permissions. The closeness of relation between users in a social graph may be determined from the obtained information.

Social graphs represent social relations between users. The social relation between two users may carry a certain level of trust and credibility. Moreover, it may carry a certain level of similarity in search intentions. As a matter of fact, some search intentions may be triggered by communications between friends. Moreover, friends tend to have, similar interests and opinions. This serves as the foundation for ranking database entries with respect to a user according to the experiences of the user's social relations including but not limited to the user's direct friends with the database entries or their related database entries.

To calculate the closeness of relation between nodes, in pending patent application Ser. Nos. 13/317,270 and 13/317,794, weighting factors are assigned to relations between users in a social graph. Weighting factors for relations in a social graph may be determined in various ways. In one embodiment of the pending patent application Ser. Nos. 13/317,270 and 13/317,794, weighting factors may be determined from the closeness of relation between two users.

In pending patent application Ser. No. 13/317,270 and 13/317,794, distances/proximities of relation between users may be calculated from the weighting factors for relations in social graphs. The calculated distances/proximities describe the closeness of relation between users.

To personalize search in a database, user-centric ranks for database entries with respect to a user may be used. Some assumptions need to be made when determining a user-centric rank for a database entry with respect to a user. It is assumed that some users connecting to a user in social graphs may have already queried a database entry or its related database entries. It is further assumed that impact factors for the database entry associated with those users may be derived from their experiences with the database entry or its related database entries.

Based on the assumptions, a rank for a database entry with respect to a query user may be determined from the impact factors for this database entry associated with users connecting to the query user in social graphs. A rank for a database entry with respect to a query user may also be dependent on the closeness of relation between the query user and users having experiences with the database entry or its related database entries. The users connecting to the query user may have distinct authorities on the database entry. The user-centric rank for the database entry may be dependent on those users' authorities on the database entry. Moreover, a query user may acquire more information about a database entry from users reachable from the query user in social graphs and having experiences with the database entry or its related database entries.

If no user reachable from a user in social graphs has queried a database entry or its related database entries, a default user independent rank may be assigned to the database entry. Alternatively, a rank calculated from other approaches including PageRank, if available, may be assigned to the database entry.

### BRIEF DESCRIPTION OF THE DRAWINGS

FIG. 1 shows a diagram for a social friendship graph and a user database entry query relation graph in which a personalized search may be achieved by the search histories of a user's friends according to the invention.

FIG. 2 shows a diagram for a social friendship graph and a user database entry query relation graph in which personalization by the search histories of a user's friends may fail according to the invention.

FIG. 3 shows a conceptual view of a social graph according to the invention.

FIG. 4 shows a diagram for a social friendship graph and a user database entry query relation graph according to the invention.

FIG. 5 shows a social graph annotated with weighting factors, path proximities and proximities according to the invention.

FIG. 6 shows a diagram for ranking database entries according to the invention.

### DETAILED DESCRIPTION OF THE INVENTION

In the following description, numerous specific details are set forth in order to provide a thorough understanding of the invention. It will be apparent to one skilled in the art, however, that the present invention may be practiced without these specific details. Accordingly, the following embodiments of the invention are set forth without any loss of generality to, and without imposing limitations upon, the claimed invention.

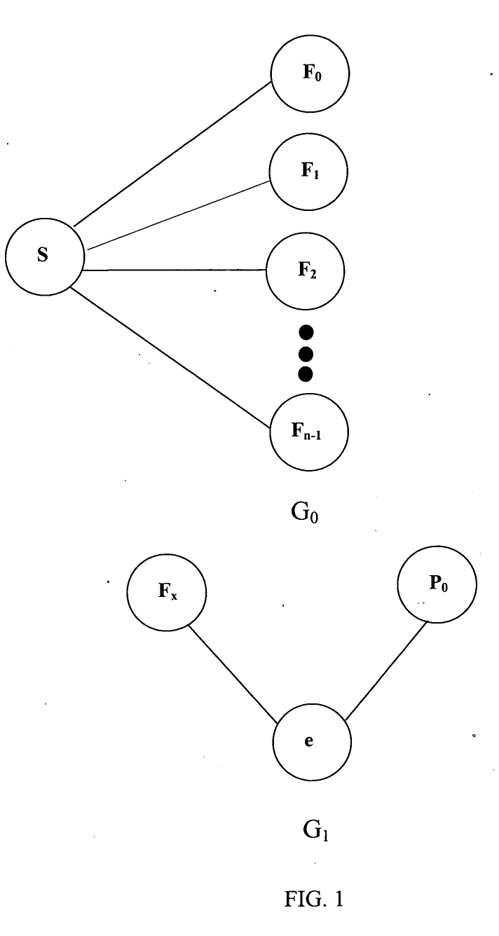

To achieve the goal of personalized search, prior art may tune user-independent ranks for database entries according to the search histories of a user and his/her friends. This is demonstrated in FIG. 1. There are two graphs in FIG. 1. G₀ is a simplified social friendship graph. Not all friendship is shown in G₀. User S has friend Fᵢ where i ε [0, n−1]. G₁ represents query relations between users and database entries. A link between a user and a database entry in G₁ means the user has queried the database entry. In G₁, e is a database entry matching S's search criteria. There are links between e and Fₓ/P₀ in G₁. The links mean that Fₓ and P₀ have queried e. In this case, a rank assigned to e with respect to S may be adjusted by Fₓ's experience with e.

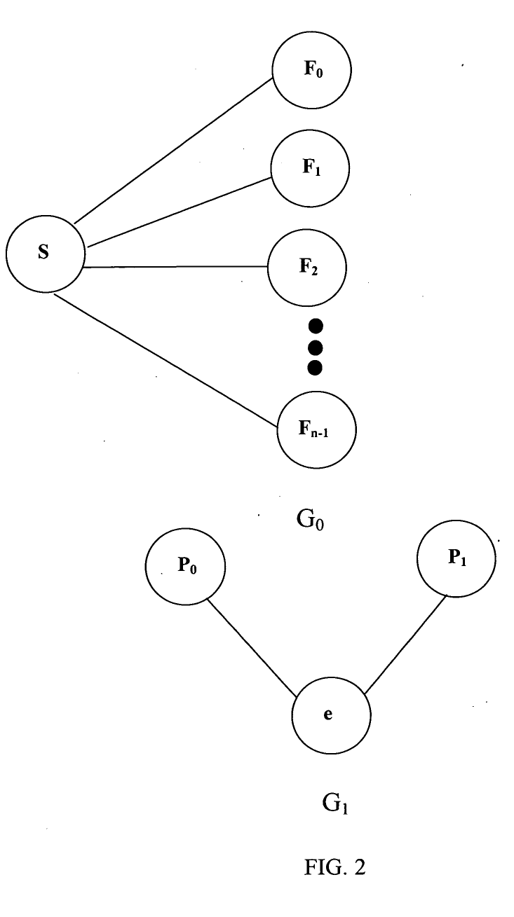

However, personalization by search histories of a user and his/her friends may sometimes be less than perfect. As shown in FIG. 2, if an entry of interest to S has not been queried by any of S's friends, the personalization may fail, which is due to the limited size of S's friend circle.

Given the limit of a user's friend circle size, a user's search intention may possibly be unique among his/her friends. In other words, the database entries which a user may be interested in may have not been queried by any of a user's friends. In this case, ranks of the database entries may not be tuned by the experiences of a user's friends. Thus personalization may fail in this case. Ideally, if everyone on Earth is a user's friend, then a user's search intention may always be shared by one of his/her friends.

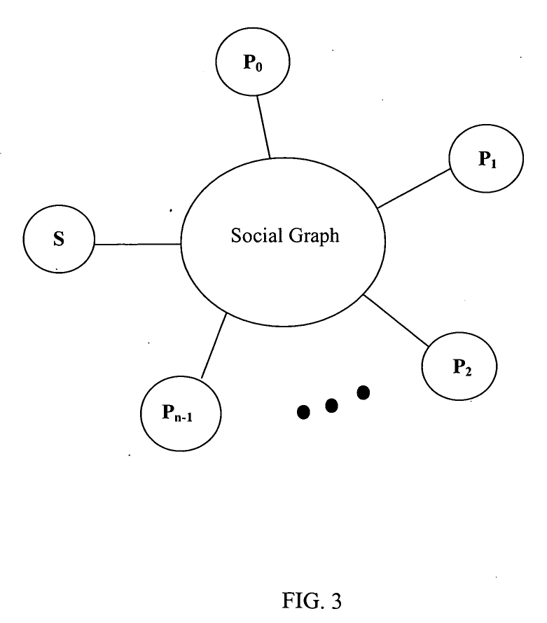

The popularity of online social networking services makes it possible to use the social graphs established by social networking services to achieve better personalization. According to the 6 degrees of separation, a user may connect to any other user in a popular social graph. A user may always share the same search intention as another user in social graphs. FIG. 3 shows a conceptual view of a social graph. Each link in this graph is symbolic and may represent multiple links to other entities in this graph. Pᵢ is one of the n users sharing S's search intention, where i ε [0, n−1]. S may be connected to the n users via a social graph.

Like friendship in real world, social graphs obtained from social networking services may carry certain levels of trust and credibility. Moreover, The connections in social graphs may also carry certain levels of similarities in search intentions. Therefore, the social relations represented by social graphs may be used to assign user-centric ranks to entries in a database.

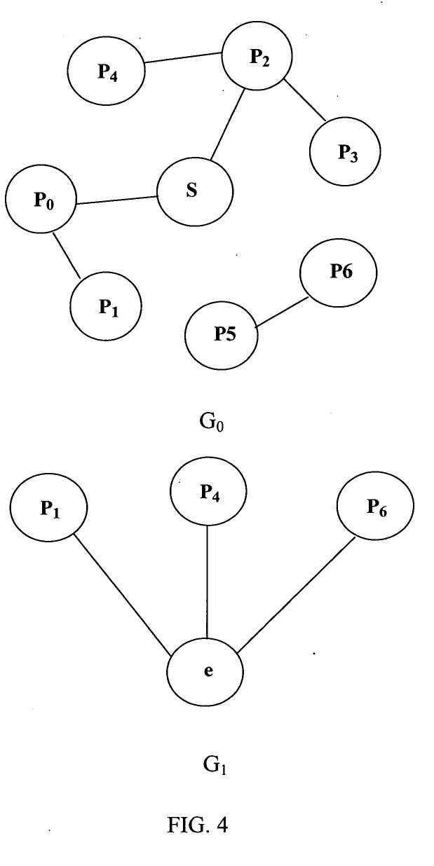

FIG. 4 shows one embodiment of the present invention. There are two graphs G₀ and G₁ in FIG. 4. G₀ is a social graph. G₁ is a user database entry query relation graph. Not all relations are shown in G₀ and G₁. e is one of the database entries matching S's search criteria. P₁, P₄ and P₆ connect to e. It means P₁, P₄ and P₆ have queried e. S's direct friend P₀ and P₂ have not queried e. As P₁ and P₄ are connected to S via P₀ and P₂ respectively, it is possible to personalize this specific search via the experiences of P₁ and P₄.

A user in a popular social graph may have hundreds of connections. Nonetheless, the connections may carry disparate levels of closeness. Family relation may carry a high level of similarity in search intentions. In another example, if there are more communications between two nodes, the relation between them may be closer as well.

In one embodiment of the present invention, methods in pending patent application Ser. Nos. 13/317,270 and 13/317,794 may be used to calculate the closeness of relation between nodes in social graphs. Specifically, weighting factors are assigned to the relations in a social graph. Given a social graph G(V, E), V represents the set of nodes in G and E represents the set of edges connecting the nodes in V. For a relation eᵢⱼ, wᵢⱼ is used to describe the closeness of relation from vᵢ to vⱼ. The closeness of relation between nodes may be determined from the assigned weighting factors.

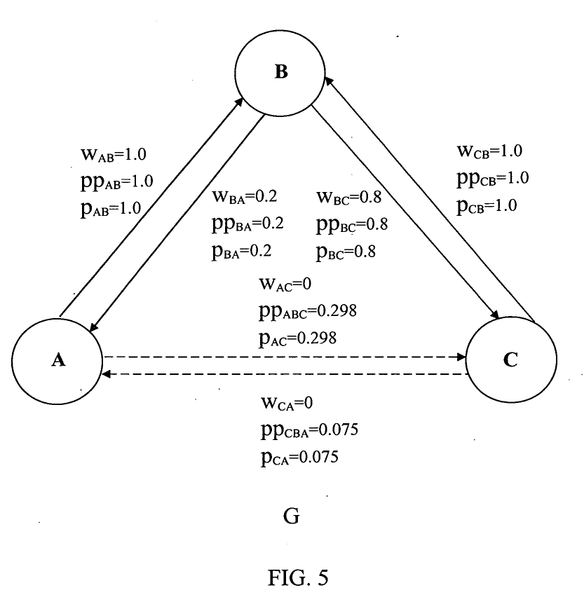

One embodiment of the pending patent application Ser. No. 13/317,794 is shown in FIG. 5. It is a friendship graph G with user A, B and C. The weighting factors for relations between users are given in FIG. 5. The weighting factor for the relation from B to A w_{BA} is 0.2 while the weighting factor for the relation from B to C w_{BC} is 0.8. There is no direct relation between A and C. However, in real world, A may connect to C via B. In other words, relations may be propagated along a path connecting the two nodes. Moreover, the propagated relations may be attenuated during propagation. In pending patent application Ser. No. 13/317,794, the propagation attribute of this relation is defined to be attenuatable. Generally, social relations are attenuatable.

In one embodiment of pending patent application Ser. Nos. 13/317,270 and 13/317,794, the weighting factors for attenuatable relations may be interpreted as a predetermined probability of selecting the next node from the current node's neighbors to traverse when searching a social graph. As the next node to visit is always one of vᵢ's neighbors in a social graph, the sum of all weighting factors for relations sourced from vᵢ is 1. That is,

$${\sum }_{j} {w}_{ij} = 1$$

Apparently, wᵢⱼ and wⱼᵢ are not necessarily equal. For this reason, the original undirected G(V, E) is converted to a directed graph G′(V, W), where an edge eᵢⱼ/eⱼᵢ in G is split into two directed edges wᵢⱼ and wⱼᵢ in G′.

wᵢⱼ may be obtained from the closeness of social relation from vᵢ to vⱼ in a social graph. In one embodiment of the present invention, it may be derived from the communications between node vᵢ and vⱼ.

In pending patent application Ser. No. 13/317,794, proximities of relation between two nodes may be used to describe the closeness of relation between the two nodes in multiple graphs. If the proximity of relation from one node to another is large, the relation between them is close too. Proximities of relation may be calculated from the weighting factors for relations in social graphs. More specifically, the proximities of relation between two nodes may be determined from the weighting factors for relations on the paths connecting the two nodes.

There may be a number of paths from a first node to a second node in a social graph. If the propagated relations between two nodes are attenuatable, path proximity may be defined to describe the propagated relations from the first node to the second node along a path. In one embodiment of pending patent application Ser. No. 13/317,794, proximity of attenuatable relation pᵢⱼ from node vᵢ to vⱼ is defined as

$${p}_{ij} = {max}_{l} {pp}_{ijl}$$

which is the maximum path proximity from vᵢ to vⱼ. ppᵢⱼₗ is the proximity for path l. Path l is one of the paths connecting vᵢ to vⱼ.

Similar to the asymmetry of weighting factors, proximities are asymmetric as well. Specifically, proximity pᵢⱼ may not be equal to pⱼᵢ.

The proximity of a path may be calculated from the weighting factors for relations on the path. Moreover, the probability of visiting node vⱼ from vᵢ following a path should be the multiplication of the probabilities for connections on the path. Therefore, in one embodiment of pending patent application Ser. No. 13/317,794, path proximity ppᵢⱼₗ may be calculated as

ppᵢⱼₗ=πwₛₜ

where wₛₜ is the weighting factor for the relation from vₛ to vₜ on path l connecting vᵢ to vⱼ.

The propagation of attenuatable relation across neighboring nodes should be an attenuating process. A propagation coefficient α is defined and should be in the interval of [0, 1]. Accordingly, in one embodiment of pending patent application Ser. No. 13/317,794, the path proximity ppᵢⱼₗ may be defined as

ppᵢⱼₗ=πw′ₛₜ

where w′ₛₜ is equal to α*wₛₜ except for the last connection on the path. The w′ₛₜ for the last connection on the path is equal to wₛₜ.

The path proximities and proximities are shown in FIG. 5. Assuming propagation coefficient α is 0.373, the path proximity pp_{ABC}=w_{AB}*α*w_{BC}=1.0*0.373*0.8=0.298. pp_{ABC} is the largest path proximity between A and C, therefore, p_{AC} is 0.298 as well.

So far, the closeness of relation between users in social graphs may be determined. It should be noted that methods other than those presented in pending patent application Ser. Nos. 13/317,270 and 13/317,794 may also be used in the present invention to calculate the closeness of relation between users in social graphs. In one embodiment of the present invention, the minimum number of connections between users in social graphs may be used as an oversimplified metric to determine the closeness of relation between users. Next personalized ranking of database entries is addressed.

Supposedly there are m entries matching S's search criteria, namely, eⱼ, where j ε [0, m−1]. Each entry eⱼ has been assigned an initial rank r⁰ⱼ. In one embodiment of the present invention, it may be determined by other ranking methods such as PageRank. In another embodiment of the present invention, if r⁰ⱼ is normalized to the interval of [0, 1], it may be assigned a mean value of the interval, i.e. 0.5.

It is assumed that there are nⱼ users having experiences with eⱼ or its related database entries. In one embodiment of the present invention, each of the nⱼ users has a closeness of relation with S represented by proximity p_{Skj}, where k ε [0, nⱼ−1]. Each of the nⱼ users has an impact factor qₖⱼ assigned for eⱼ, which is determined from a user's experience with eⱼ or its related database entries. If a user is interested in eⱼ or its related database entries, he/she may spend a long time on eⱼ or its related database entries. If interested, a user may access eⱼ or its related database entries a number of times. An impact factor may also be determined from a user's level of interest, review, rating and opinion about a database entry or its related database entries. In one embodiment of the present invention, qₖⱼ may be in the interval of [−1, 1], depending on whether a user has a positive or negative experience with eⱼ or its related database entries. If a user has no experience with eⱼ or its related database entries, qₖⱼ may be zero.

It is possible that two database entries may be related. As an oversimplified example, Italian cuisine and spaghetti are related. A person who likes Italian cuisine may like spaghetti as well. If a user has queried Italian cuisine, the user's experience with Italian cuisine may be used to predict his/her experience with spaghetti. Techniques including machine learning may be used to determine if two database entries are related. A user may not have queried a database entry. Nonetheless, the user's experience with one or more related database entries may be used to determine an impact factor for the database entry associated with the user.

Moreover, aₖⱼ is defined to represent the authority of user k on eⱼ. In one embodiment of the present invention, if user k has expertise on eⱼ, aₖⱼ may be large. In another embodiment of the present invention, aₖⱼ may be determined from information obtained from social networking services including but not limited to the profile, messages of user k. In yet another embodiment of the present invention, if the search intention of user k has a large probability of matching that of S, aₖⱼ may be large as well. aₖⱼ may also be derived from the number of times or frequencies search intentions of user k have matched search intentions of S.

In one embodiment of the present invention, the problem of ranking eⱼ with respect to S may be formulated as:

rⱼ=f(rⱼ⁰, p_{S0j}, . . . , p_{Sn}_{ⱼ}₋₁ⱼ, q₋₁ⱼ, q₀ⱼ, . . . , qₙ_{ⱼ}₋₁ⱼ, a₋₁ⱼ, a₀ⱼ, . . . , aₙ_{ⱼ}₋₁ⱼ)

Note that q₋₁ⱼ represents a user's predicted impact factor for eⱼ and a₋₁ⱼ represents the self authority of a user on eⱼ. Both q₋₁ⱼ and a₋₁ⱼ may be derived from a user's search history of related database entries.

There may be various ways to determine the implementation of function f. Techniques such as closed form representation, curve fitting, table lookup, etc., may be used to find a best solution. In one embodiment of the present invention, rⱼ may be determined as:

$${r}_{j} = sin ( π * 0.25 * {r}_{j}^{0} * ( 1 + {\sum }_{k = - 1}^{{n}_{j} - 1} {w}_{kj} * {q}_{kj} ) ) .$$

In this embodiment of the present invention, rank rⱼ⁰ is normalized to [0, 1]. The sine function is used to convert the calculated value into a number within the interval of [0, 1]. wₖⱼ represents the importance of qₖⱼ and it is in the interval of [0, 1]. qₖⱼ is within [−1, 1].

In one embodiment of the present invention, wₖⱼ may be determined as a normalized product of a user's proximity and authority, as shown below:

$${w}_{kj} = \frac{{p}_{kj} * {a}_{kj}}{{\sum }_{i = - 1}^{{n}_{j} - 1} {p}_{ij} * {a}_{ij}}$$

For convenience of representation, p₋₁ⱼ is used and is set to 1 in this embodiment of the present invention.

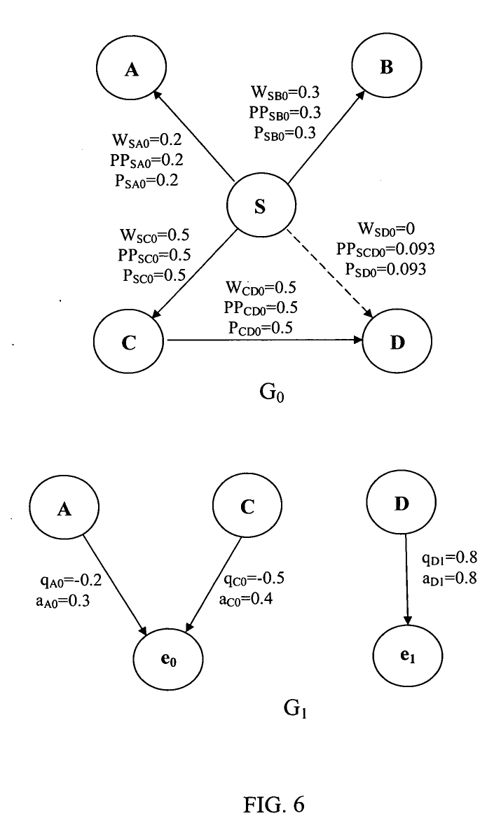

FIG. 6 shows one embodiment of the present invention. There are two graphs in FIG. 6. G₀ is a social graph annotated with weighting factors, path proximities and proximities. A, B and C are directly connected to S, which means A, B and C are direct friends of S. D is not directly connected to S. Nonetheless, D is connected to S via C. G₁ is a user database entry query relation graph annotated with impact factors and authorities. Please note that not all relations are shown in G₀ and G₁.

Supposedly there are two entries e₀ and e₁ matching S's search criteria. The initial user independent ranking vector r⁰ is [0.5, 0.3]^{T} for e₀ and e₁. r₀⁰(0.5) is larger than r₁⁰(0.3). It means that most users may deem e₀ more important than e₁. However, as shown in G₁, S's direct friend A and C have negative experiences with e₀. Moreover, D, who is indirectly connected to S, has a fairly positive experience with e₁. Thus, it is expected that the personalization should rank e₁ higher than e₀. In this example, it is assumed that S's self authorities on e₀ and e₁, i.e. a₋₁₀ and a₋₁₁, are 0.

According to one embodiment of the present invention, r₀ may be calculated as:

$${r}_{0} = sin ( π * 0.25 * {r}_{0}^{0} * ( 1 + \frac{{p}_{SA 0} * {a}_{A 0} * {q}_{A 0} + {p}_{SC 0} * {a}_{C 0} * {q}_{C 0}}{{p}_{SA 0} * {a}_{A 0} + {p}_{SC 0} * {a}_{C 0}} ) )$$

### That is

$${r}_{0} = sin ( 3.142 * 0.25 * 0.5 * ( 1 + \frac{0.2 * 0.3 * ( - 0.2 ) + 0.5 * 0.4 * ( - 0.5 )}{0.2 * 0.3 + 0.5 * 0.4} ) )$$

r₀ is 0.222.

Similarly, r₁ may be calculated as:

$${r}_{1} = sin ( π * 0.25 * {r}_{1}^{0} * ( 1 + \frac{{p}_{SD 0} * {a}_{D 1} * {q}_{D 1}}{{p}_{SD 0} * {a}_{D 1}} ) )$$

### That is,

$${r}_{1} = sin ( 3.142 * 0.25 * 0.3 * ( 1 + \frac{0.093 * 0.8 * 0.8}{0.093 * 0.8} ) )$$

r₁ is 0.412.

In this example, personalized ranking vector r is [0.222, 0.412]^{T}, which is different from initial ranking vector r⁰, i.e. [0.5, 0.3]^{T}. The personalized ranks calculated by the present invention are consistent with the experiences of the users connecting to S in a social graph.

In one embodiment of the present invention, the database entries' information/links may be displayed as a directory listing. In another embodiment of the present invention, the search may be based on textual matching of user specified keywords. With the advancement of voice recognition technology, the search criteria may be derived from a user's voice. The calculated ranks may be displayed as well. Moreover, in one embodiment of the present invention, only impact factors associated with users having at least a minimum level of relation closeness with a query user are used in determining an assigned score. The minimum level of relation closeness may either be a default value or be specified by a query user.

In one embodiment of the present information, the users associated with the impact factors used in calculating a user-centric rank may be listed. A path in social graphs connecting a query user and a user associated with an impact factor used in calculating a rank with respect to the query user may be listed as well. To acquire more information about a database entry, a query user may communicate with a user who is associated with an impact factor used in calculating a user-centric rank. In one embodiment of the present invention, the communication may be conducted using the communication facilities provided by social networking services such as email, messaging, etc. In another embodiment of the present invention, a query user may obtain information including messages regarding a database entry from social networking services with permissions. In yet another embodiment of the present invention, the impact factors used in calculating a user-centric rank may be constrained to the impact factors of a group. The group may either be created by a query user or be obtained from social networking services.

When any information is disclosed, users' privacies should be respected. If needed, users' permissions should be obtained.

It should be noted that the present invention may be applied to one or more social graphs obtained from one or more social networking services. If a user has accounts on multiple social networking services, these accounts may be linked to the same user.

Unlike the PageRank algorithm, methods consistent with the present invention require no linking relation between database entries. The entries in a database may or may not have linking relation between them. For instance, a database may store advertisements to be delivered to users. In most cases, advertisements in an advertisement database may not have linking relation between them. The goal of a search is to find relevant advertisements that may be of interest to a user. Advertisements may be selected according to their user-centric ranks with respect to a user.

Methods consistent with the present invention may be applied to a database that stores information about a document, an advertisement, a celebrity, a public figure, an artist, a band, a group, a company, a business, an organization, an institution, a place, an event, a brand, a product, a service, a buyer, a seller, etc. A user's impact factor for a database entry may be determined by the user's level of interest, review, rating and opinion on the database entry or its related database entries. A score assigned to a database entry with respect to a user may represent a prediction of the user's level of interest, review, rating and opinion on the database entry.

The present invention has been disclosed and described with respect to the herein disclosed embodiments. However, these embodiments should be considered in all respects as illustrative and not restrictive. Other forms of the present invention could be made within the spirit and scope of the invention.

What is claimed is:

1. A computer implemented method of scoring a plurality of entries in a database with respect to a plurality of users, comprising:
obtaining information of a plurality of users from one or more social networking services, at least some of the users having relations with other users;
determining the closeness of relation between users based on the obtained information;
identifying an impact factor for a database entry associated with a user, the impact factor being dependent, on the user's experience with the database entry or database entries related to the database entry;
assigning a score to a database entry with respect to a query user, the score being dependent on the database entry's impact factors of associated users and the closeness of relation between the query user and the users associated with the database entry's impact factors; and
processing the database entries according to their scores with respect to a query user.

2. The method of claim 1, wherein an identified impact factor for a database entry associated with a user is dependent on the time the user has spent on the database entry or database entries related to the database entry.

3. The method of claim 1, wherein an identified impact factor for a database entry associated with a user is dependent on the user's level of interest, review, rating and opinion on the database entry or database entries related to the database entry.

4. The method of claim 1, wherein an identified impact factor for a database entry associated with a user is dependent on the number of times the user has accessed the database entry or database entries related to the database entry.

5. The method of claim 1, wherein an assigned score to a database entry with respect to a query user is dependent on the query user's experience with one or more database entries related to the database entry.

6. A computer implemented method of scoring a plurality of entries in a database with respect to a plurality of users, comprising:
obtaining information of a plurality of users from one or more social networking services, at least some of the users having relations with other users;
determining the closeness of relation between users based on the obtained information;
identifying an impact factor for a database entry associated with a user, the impact factor being dependent on the user's experience with the database entry or database entries related to the database entry;
generating an initial estimate on a score for a database entry with respect to a query user, the initial estimate either being a default value or being determined by other ranking methods;
updating the estimate of the score for a database entry with respect to a query user, the score being dependent on the database entry's impact factors of associated users and the closeness of relation between the query user and the users associated with the data base entry's impact factors; and
processing the database entries according to their updated scores with respect to a query user.

7. The method of claim 1, wherein an assigned score to a database entry is dependent on the authority of each of the users associated with the database entry's impact factors used in assigning the score.

8. The method of claim 7, wherein the authority of a user is determined based on the user's information obtained from one or more social networking services.

9. The method of claim 7, wherein the authority of a user is determined based on the probability of matching the user's search intentions to a query user's search intentions.

10. The method of claim 7, wherein the authority of a user is determined based on the number of times the user's search intentions have matched a query user's search intentions.

11. The method of claim 1, wherein only impact factors associated with users having at least a minimum level of relation closeness with a query user are used in assigning a score, the minimum level of relation closeness either being a default value or being specified by the query user.

12. The method of claim 1, wherein only impact factors associated with users belonging to a group are used in assigning a score, the group either being created by the query user or being obtained from one ore more social networking services.

13. The method of claim 1, wherein the processing the database entries includes:
displaying information about the database entries and links to the database entries as a directory listing.

14. The method of claim 1, wherein the processing the database entries includes:
displaying information about the database entries and links to the database entries as a directory listing; and
displaying annotations including information about the score of each database entry.

15. The method of claim 14, wherein the annotations include information of the users associated with the impact factors used in assigning a score.

16. The method of claim 14, wherein the annotations include a path of users connecting a query user to a user associated with an impact factor used in assigning a score to a database entry with respect to the query user, the path of users being obtained from one or more social networking services.

17. The method of claim 1, wherein a query user may communicate with a user associated with an impact factor used in assigning a score to a database entry with respect to the query user.

18. The method of claim 1, wherein a query user may communicate with a user associated with an impact factor used in assigning a score to a database entry with respect to the query user via one or more social networking services.

19. The method of claim 1, wherein a query user may obtain information including messages of a user who is associated with an impact factor used in assigning a score to a database entry with respect to the query user, the information being obtained from one or more social networking services with permissions.

20. The method of claim 1, further comprising:
processing the database entries based on criteria including but not limited to textual matching.

21. A computer-readable medium that stores instructions executable by one or more processing devices to perform a method for scoring a plurality of entries in a database with respect to a plurality of users, comprising:
instructions for obtaining information of a plurality of users from one or more social networking services, at least some of the users having relations with other users;
instructions for determining the closeness of relation between users based on the obtained information;
instructions for identifying an impact factor for a database entry associated with a user, the impact factor being dependent on the user's experience with the database entry or database entries related to the database entry;
instructions for assigning a score to a database entry with respect to a query user, the score being dependent on the database entry's impact factors of associated users and the closeness of relation between the query user and the users associated with the database entry's impact factors; and
instructions for processing the database entries according to their scores with respect to a query user.

22. The method of claim 1, wherein a database entry may represent an entity including but not limited to a document, an advertisement, a celebrity, a public figure, an artist, a band, a group, a company, a business, an organization, an institution, a place, an event, a brand, a product, a service, a buyer and a seller.
